(19) United States
(12) Patent Application Publication
(10) Pub. No.: US 2003/0226114 A1
(43) Pub. Date: Dec. 4, 2003

(54) System and method for composing documents

(75) Inventors: Larry Lee Feldman, San Pedro, CA (US); Mark Liu Stevens, Laguna Hills, CA (US)

Correspondence Address: Gerald W. Maliszewski, Suite 157, 11440 West Bernardo Court, San Diego, CA, 92127, US

(73) Assignee: Sharp Laboratories of America, Inc.

(21) Appl. No.: 10/465,166

(22) Filed: Jun. 19, 2003

Related U.S. Application Data
(63) Continuation-in-part of application No. 09/789,413, filed on Feb. 20, 2001.

(51) Int. Cl. G06F 17/00

(52) U.S. Cl. 715/523

(57) ABSTRACT

A system and method are provided for composing documents. The method comprises: accepting an electronically formatted document; converting the document into a metafile format description; and, arranging the converted documents in a Composer file. In some aspects, converting the documents into a metafile format description includes converting the documents into printer commands. The method may: create a call for a graphical device interface (GDI) function; and, supply GDI function parameters. In other aspects, arranging the converted documents in a Composer file includes arranging the GDI function calls and parameters in a Windows enhanced metafile (EMF) document. In one aspect, a Composer file is created with images differentiated by logical pages. Then, the method further comprises: modifying the edge margins of the composer file pages, for example, the footers and headers. Modifying the edge margins includes: either creating a page overlay; and/or, resizing a page.

### RELATED APPLICATIONS

This application is a continuation-in-part of a pending patent application entitled, METHODS AND SYSTEMS FOR ELECTRONICALLY GATHERING AND ORGANIZING PRINTABLE INFORMATION, invented by Stevens et al., Ser. No. 09/789,413, filed Feb. 20, 2001.

### BACKGROUND OF THE INVENTION

1. Field of the Invention

This invention generally relates to digital document processing and, more particularly, to a system and method for arranging converted documents in a Composer™ file, using graphical device interface (GDI) function calls and parameters in a Windows-like enhanced metafile document.

2. Description of the Related Art

The integration of computer software has advanced to the point where complex multimedia presentations may be produced with only a few applications. However, the needs of users are diverse and no application has evolved that is ideal for all users, in all situations. Consequently, the production of presentations and complex documents generally involves the use of different processing applications that need not be particularly well suited to particular elements of a document or presentation. Several file formats also exist that can complicate the integration of information into a single unit, forcing a presentation organizer to utilize multiple applications in the creation of partial presentations that must be organized and compiled manually.

Using current presentation and document preparation applications, a user needs to produce printed packets of information coming from several different sources. Typically, hard copy output from each application is manually assembled into a master hard copy of a final packet. Various files are printed and assembled. Pictures, photographs and other graphical information may need to be manually cut and pasted into other documents. Once the packet is organized, page numbering, indices, tables of contents, title pages and other elements may need to be generated and tediously compiled with the packet elements. If the original source of each element is to be documented, it may need to be manually annotated, further complicating the process.

Once the packet is fully compiled, it will exist only in hard copy form. Copies will need to be made for each recipient and, if not re-converted to an electronic format, distributed through a time-consuming and expensive manual process such as traditional mail or courier services. If faster distribution is desired, a user may fax the document or scan the document, thereby converting the document back to an electronic format that may be emailed or otherwise distributed electronically. While this conversion back to an electronic format enables quick electronic distribution, the electronic format is typically not compatible with any of the original document preparation applications. Electronically editing the document format then involves tedious conversion processes, which may lose formatting and other important document elements.

Conversion to a fax format for distribution creates a product that suffers from poor resolution. Fax quality is generally much poorer than that obtained from a standard printer driver. Printers can routinely perform at a resolution of 600 dots per inch (dpi), whereas a fax is, at best, on the order of 150 to 200 dpi. Even with a good resolution electronic display monitor (i.e., 1600×1200), the dots per inch is still on the order of 100 to 150 (although color content is much richer). The ability to print and view without losing detail, color content and quality is a big advantage over faxing.

Some conventional document-processing applications permit headers and footers, with page numbers, to be added to the documents that they create. However, none of these applications gather all the document pages into a single file, allowing the opportunity to superimpose a “master” header and footer to the set.

It would be advantageous if a document could be converted into a file format that permitted a quick and intuitively obvious method of adding, deleting, or editing header and footer information.

### SUMMARY OF THE INVENTION

The present invention enhances the production of printed output based on arbitrary sources of input, such as word processors, spreadsheets, photographs, etc. The present invention solution advances two different approaches in the control of a master document header/footer. Generally, the user can either overlay the underlying page, covering up parts, and providing their own text. Or, the user can frame the underlying page, shrinking the complete contents to fit between the master header and footer.

Accordingly, a system and method are provided for composing documents. The method comprises: accepting at least one electronically formatted document; converting the documents into a metafile format description; and, arranging the converted documents in a Composer file, as defined below. In some aspects of the method, converting the documents into a metafile format description includes converting the documents into printer commands. For example, the method may: create a call for a graphical device interface (GDI) function; and, supply GDI function parameters. In other aspects, arranging the converted documents in a Composer file includes arranging the GDI function calls and parameters in a Windows enhanced metafile (EMF) document.

In one aspect, arranging the converted documents in a Composer file includes creating a Composer file with images differentiated by logical pages. Then, the method further comprises: modifying the edge margins of the composer file pages. For example, the footers and headers of the Composer file pages may be modified. Modifying the edge margins includes either: creating a page overlay; or, resizing a page.

Creating a page overlay includes: selecting edge margin areas; and, covering the selected areas with a white opaque ribbon image. In some aspects, contents are generated to fill the selected areas such as page number, composer file name, date, and/or revision number.

Resizing a page includes: selecting edge margin areas; creating a white opaque ribbon to cover the selected areas; modifying the size of the image; and, forming a modified page with the selected edge margins and resized image. When footer and header areas are selected, the image is resized to fit between selected footer and header areas.

Additional details of the above-described method and a system for composing documents are provided below.

### BRIEF DESCRIPTION OF THE DRAWINGS

FIG. 1 is a schematic block diagram of the present invention system for composing documents.

FIG. 2 is an exemplary first page of a Composer document, displayed in the print preview mode of a Composer application.

FIG. 3 is an exemplary Composer control menu.

FIG. 4a is an example of the document of FIG. 2, modified using the overlay variation of the invention, while FIG. 4b is an example using the frame variation.

FIG. 5 is a flowchart illustrating the present invention method for composing documents.

### DETAILED DESCRIPTION OF THE PREFERRED EMBODIMENTS

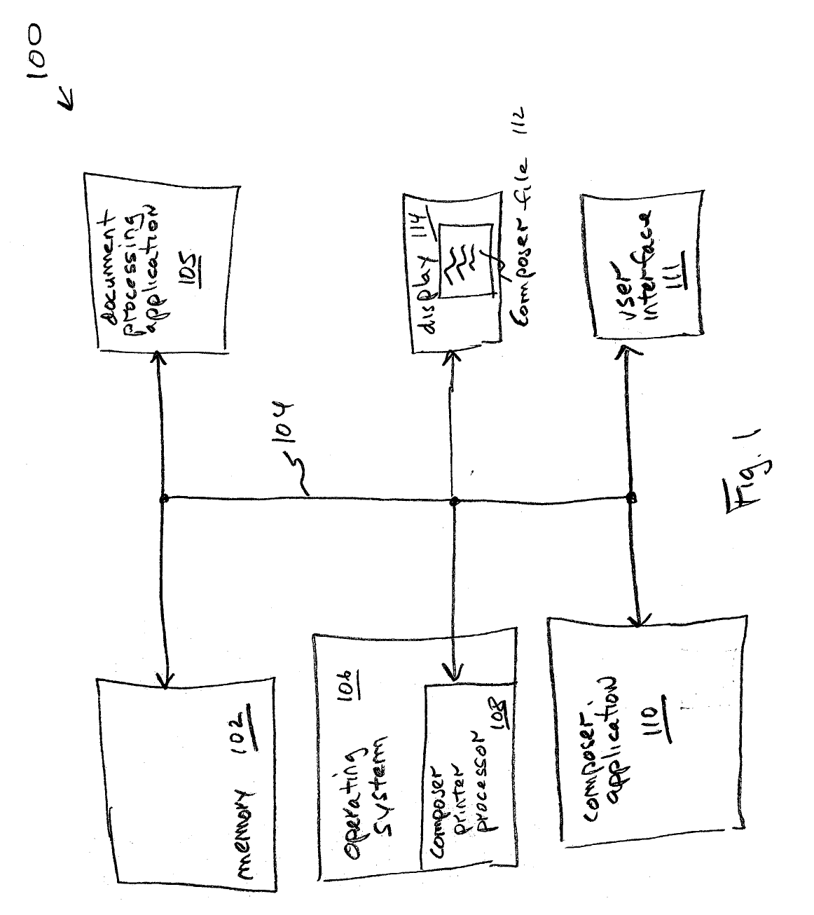

FIG. 1 is a schematic block diagram of the present invention system for composing documents. The system 100 comprises a memory 102 having an interface on line 104 to accept and supply electronically formatted documents. The documents may be a product of a conventional document processing application 105, such as Internet Explorer (HTML), Photoshop (GIF, JPEG) and Acrobat (PDF), to name a few examples. The invention is not limited to any particular type of processing application. Typically, the memory interface is a data/address bus 104. The system 100 includes an operating system 106 with a Composer printer processor 108. The Composer printer processor 108 has an interface on line 104 to accept the documents from memory 102 and convert the documents into a metafile format description. The converted documents are supplied at the interface on line 104. The operating system may be a Windows, Unix, or Macintosh operating system (OS) system for example. The present invention system is not limited to any particular operating system.

A Composer application 110 has an interface on line 104 to accept the converted documents and an interface on line 104 to accept user commands. The user commands can be entered from an interface 111, such as a keyboard for example, or stored as a default option in memory 102. The Composer application 110 arranges the converted documents in response to user interface commands and supplies the composed documents at an interface on line 104. A Composer file 112, including composed documents, is supplied from the Composer application 110. In some aspects, the Composer file 112 is stored in the memory 102. It should be understood that the above-mentioned applications and operating systems may be enabled as software instruction sets that are stored in a memory and enabled with a microprocessor (not shown).

In some aspects of the system 100, the Composer printer processor 108 includes a printer driver, or is associated with a print driver (not shown) that is also stored in the operating system 106. The Composer printer processor 108 converts the documents into printer commands either directly, or through communications with an associated print driver. For example, the Composer printer processor 108 may be a Composer Recorder (CR) that includes a printer driver and other software that “intercept” output that would otherwise be destined to a printer. The CR 108 may direct the data to a display 114 and the Composer application 110 then accept user commands to operate on the displayed data. More specifically, the Composer printer processor 108 converts the documents into a metafile format description by creating a call for graphical device interface (GDI) functions and supplying GDI function parameters. Alternately stated, the Composer printer processor 108 may pass metafile format documents (Composer file) 112 to the Composer application 110, that is open as an operating system window.

In some aspects of the system, the Composer file 112 is a Windows enhanced metafile (EMF) file including the GDI function calls and parameters. A Windows metafile is a file that may include text, graphics, or a bitmap. The .WMF extension is used for 16-bit applications, while the .EMF extension is used for 32-bits. The Windows metafile includes Windows commands, embodied as GDI calls, to create images. To create a display or print a page, the Composer printer processor 108 makes a call to a particular GDI function and uses parameters from the object to be created. Conventionally, the GDI creates the object by sending commands to the display (or printer) to actually render the image. The metafile may also be referred to as a page-format file, as it retains the appearance of each page of the original document, as it would appear if printed. Although a Windows example has been used to explain the system 100, it should be understood that the system 100 is not limited to any particular operating system or word processing application.

In one specific variation, the Composer application 110 arranges the converted documents in the Composer file 112 by creating a Composer file with images differentiated by logical pages. These logical pages may correspond to the pagination of the original document generated by the document processing application 105. Further, the Composer application 110 modifies the edge margins, either vertical or horizontal, of the composer file pages in response to user interface commands. More particularly, if horizontal edges are selected, the Composer application 110 may modify the footers and headers of the pages in the Composer file 112.

There are two modes of operation. The Composer application 110 modifies the edge margins by either creating a page overlay in the Composer file 112, or resizing pages in the Composer file 112. Using horizontal edges as an example, the Composer application 110 creates a page overlay by accepting user interface commands that select the horizontal edge margin areas. Then, the Composer application 110 covers the selected areas with a white opaque ribbon image. The white opaque ribbon image acts to cover with white (or the default background color) any words or images in the selected areas. The Composer application 110 user interface 111 may accept content fill instructions and, following the covering of the selected areas with the white opaque ribbon image, fill the selected areas with the accepted contents. For example, a footnote may include the pagination of a first document that has been incorporated into second document (the Composer file 112). The white opaque ribbon image can be used to cover the first document page numbers and the area filled with different page numbers that accord with the second document pagination. Other fill instructions, besides page number, may include the Composer file name, date, revision number, source file for the original page, or proprietary information banner, to name a few examples.

More specifically, the Composer application 110 covers the selected areas with a white opaque ribbon image by creating graphical device interface (GDI) calls at the logical end of pages in the composer file. That is, the GDIs “draw” the white opaque ribbon images on the Composer file pages.

In the second mode, the Composer application 110 resizes a page by accepting user interface commands that select edge margin areas and create a white opaque ribbon to cover the selected areas. The Composer application 110 modifies the size of the image and supplies a modified page to the Composer file 112 with the selected edge margins and resized image. For example, The Composer application 110 accepts user interface commands that select footer and header areas and resizes the image to fit between selected footer and header areas. When the Composer application 110 accepts user commands that select horizontal edge margins, the application 110 compresses the image as follows:

Ir=(Lp−Lhm)/Lp;

where Ir=the compression ratio of the resized image;

where Lp=page length; and,

where Lhm=length of horizontal edge margins.

While the page overlay mode is practical for applications where a user is seeking to remove or modify the footers and headers of an original document, the page resizing mode is practical for keeping original document headers and footers. Further, although horizontal edge examples have been given above, the present invention system can also be used to operate on vertical edges. For example, vertical edges can be selected and covered to hide line numbers. When vertical edges are of interest, the Composer application 110 compresses the image as follows:

Ir=(Lw−Lvm)/Lw;

where Ir=the compression ratio of the resized image;

where Lw=page width; and,

where Lvm=width of vertical edge margins.

### Functional Description

The present invention Composer application permits a document to be constructed from different applications and printed as a single unit. The layout and content of the original application can be preserved in the composed printed output. Many users, however, want to put a common header and/or footer on the composed printed output, overlaying or, in some cases, framing the original content. Prior to this invention, users have had to assemble the physical pages of the final document, create a physical template or frame with the header/footer information on it (with a “hole” in the middle to let the original document page show through), and then take the taped-together master back to the copier to create the copy sets for distribution.

This invention permits a single electronic header/footer set to cover the whole Composer document, independent of the contents of the individual pages of the original applications. The user can also give the Composer document a set of sequential page numbers that may be different from the page numbering of the original documents used to create the Composer document. These options, coupled with Composer's ability to accept pages from arbitrary applications, provides a unique capacity to put common headers on a collection of pages assembled electronically from several different sources.

There is nothing especially unique about modifying the contents or sizing of a given Header/Footer. The Composer Header/Footer, however, can be applied to a Composer document using two unique methods:

1. The Overlaid Header/Footer. This option keeps the page size and layout of the original document page intact, and creates an opaque white ribbon across the top and bottom of the page. Anything under the ribbon from the original document is covered up and, thus, invisible when the Composed document is printed. The dimensions of the ribbon are controlled by the user, as are the contents of the header/footer fields.

2. The Frame Header/Footer. This option lays down the same ribbons described in option 1, but then resizes the original page to fit in the space between the header and footer ribbons. The aspect ratio of the original page is maintained, so the content of the composed page, when printed, are a smaller page image than the original. The actual size of the page image, when printed, depends on the size of the header/footer ribbons.

The Composer application manipulates headers and footers by adding GDI calls to the logical end of each page in the internal EMF description of the page. This additional information is stored with the Composer file. The ribbons of the header and footer are applied to the final page image after the original is rendered, creating the opaque overlay effect.

If the user selects the frame (resizing) option, the height of the header and footer is subtracted from the physical page length. The ratio is defined by:

$$\frac{Physical page length - ( Height of Header + Height of Footer )}{Physical page length}$$

This is the compression factor applied to the original page contents in both the vertical and horizontal directions. The compression factor is applied to the original EMF page description before rendering the output, causing the page to shrink when finally printed, so that it fits between the header and footer definitions that are also part of that page.

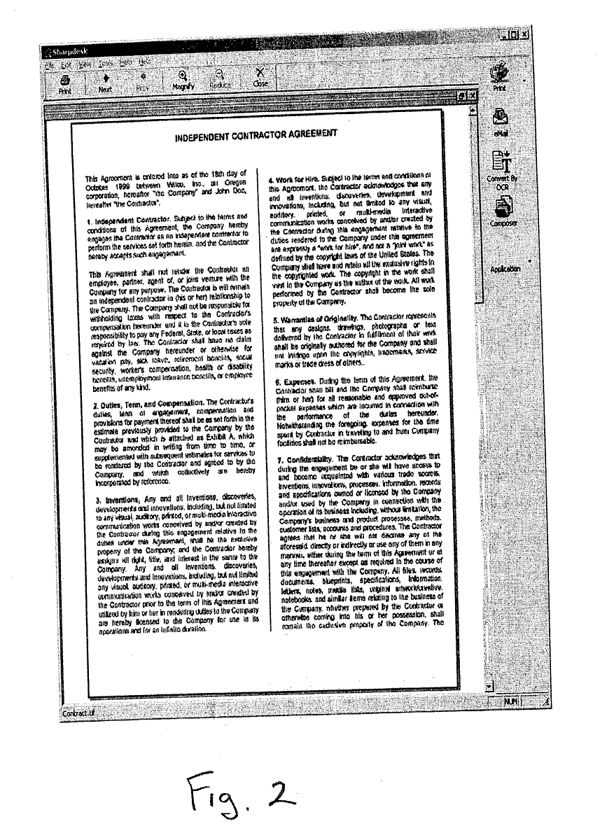

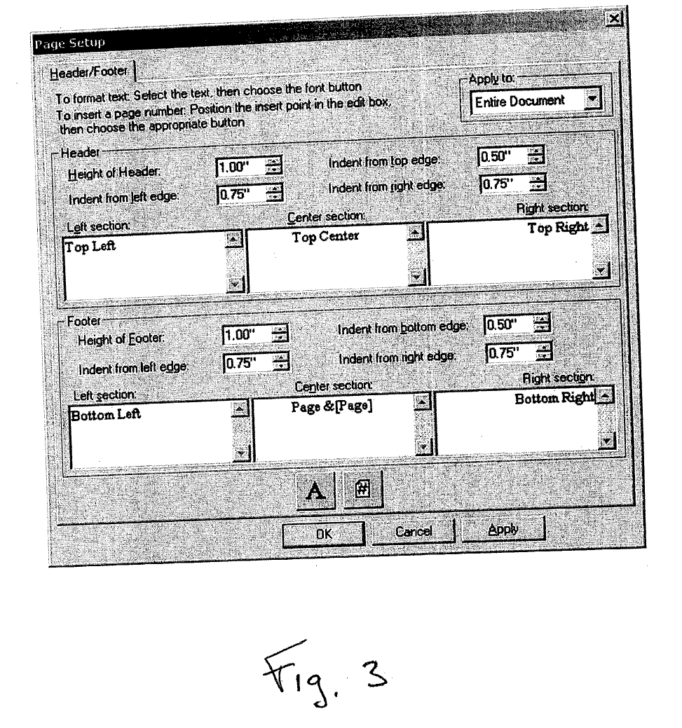

FIG. 2 is an exemplary first page of a Composer document, displayed in the print preview mode of a Composer application. Assume that the “Independent Contractor Agreement” is the internal header carried by the original application.

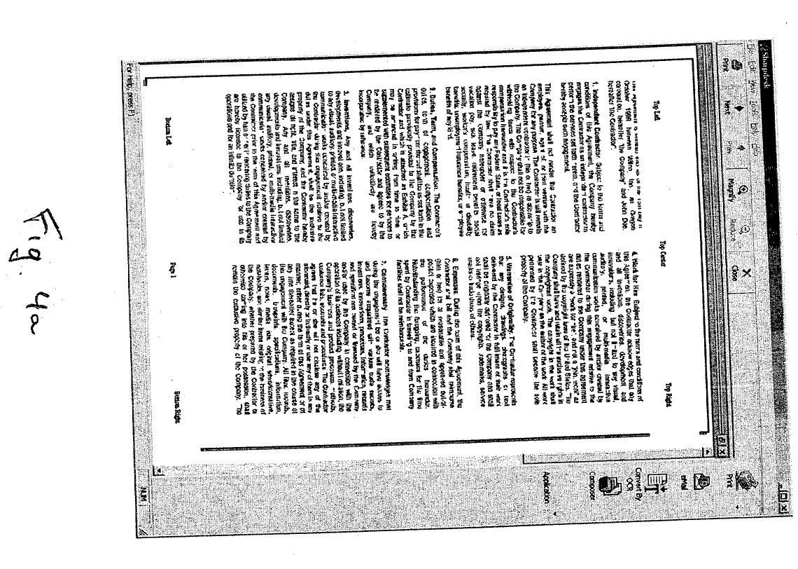

FIG. 3 is an exemplary Composer control menu. To apply a new header to the document of FIG. 2, this control can be used to define the size, contents, and layout of the header and footer ribbons. The resultant header/footer pair is dependent upon whether the overlay or frame option is chosen.

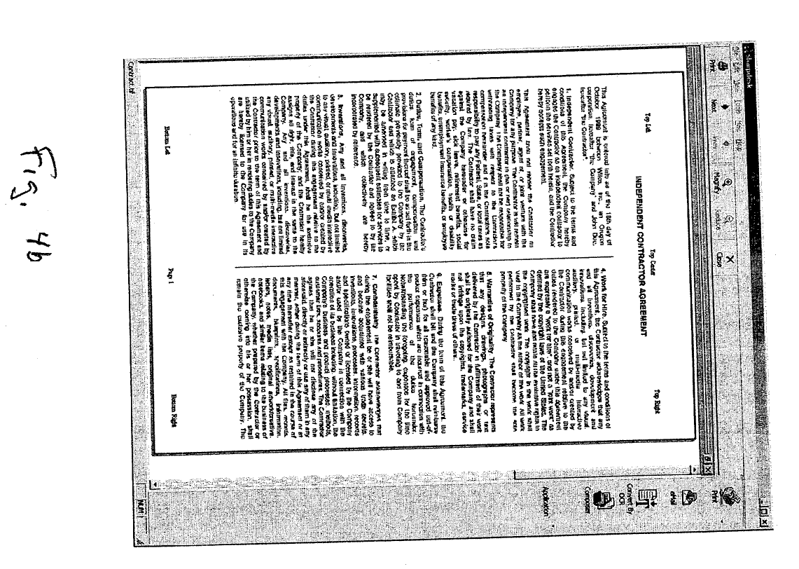

FIG. 4a is an example of the document of FIG. 2, modified using the overlay variation of the invention, while FIG. 4b is an example using the frame variation. Note that with the overlay result (FIG. 4a), the original header (“Independent Contractor Agreement”) is gone, replaced by the one provided in the Composer header control. With the frame result (FIG. 4b), the previous header is still present, but positioned below the Composer header. Note as well, the page number at the center bottom of the page. The subsequent pages of the Composer document will have sequential numbers in this position. If the original document had page numbers of its own, the overlay option can be used to blank them out, preventing confusion to the reader of the final document.

The page descriptions of the Composer header and footer are stored with each page of the document. They can be removed or modified at a later time without changing the underlying contents of the original application's pages.

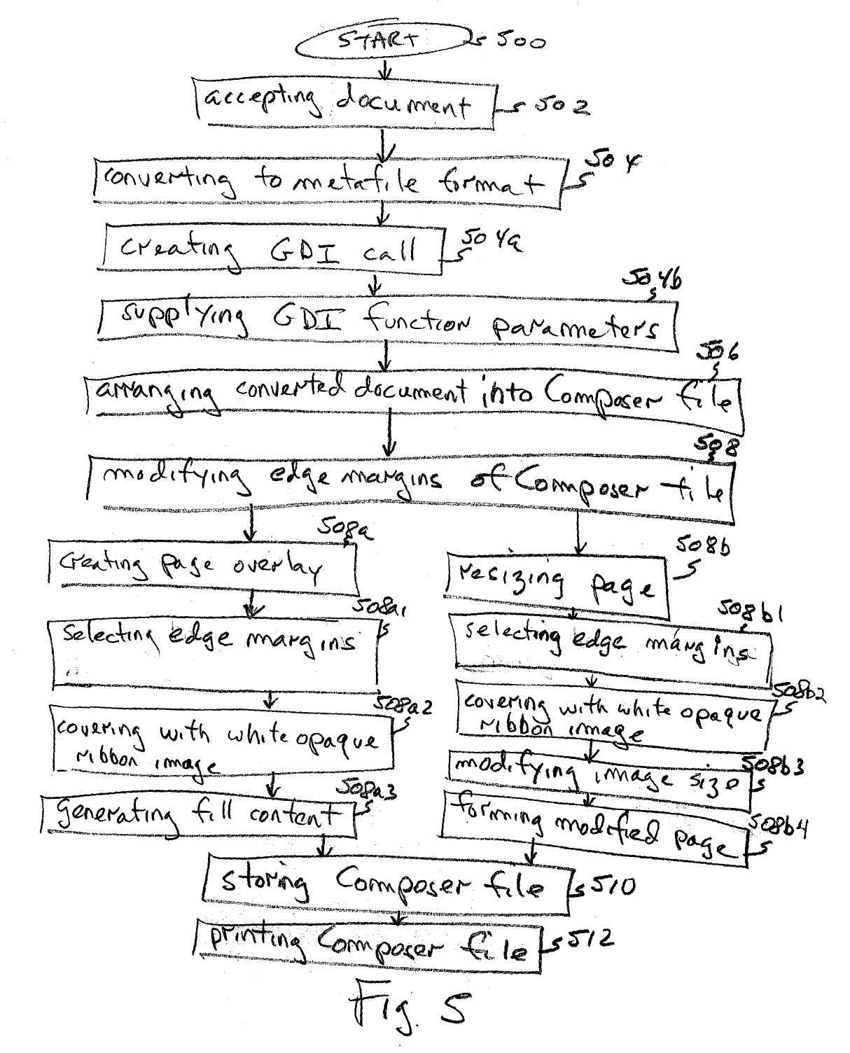

FIG. 5 is a flowchart illustrating the present invention method for composing documents. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 500.

Step 502 accepts at least one electronically formatted document. Step 504 converts the documents into a metafile format description. In one aspect of the method, Step 504 converts the documents into printer commands. Step 506 arranges the converted documents in a Composer file. In one aspect, Step 506 creates a Composer file with images differentiated by logical pages. Step 508 modifies the edge margins of the Composer file pages. The horizontal edges are of particular interest, although the method can also be used to modify the vertical edges just as well. Step 510 stores the Composer file. Step 512 prints the Composer file.

In some aspects, converting the documents into a metafile format description in Step 504 includes substeps. Step 504a creates a call for a graphical device interface (GDI) function. Step 504b supplies GDI function parameters. In other aspect, arranging the converted documents in a Composer file in Step 506 includes arranging the GDI function calls and parameters in a Windows enhanced metafile (EMF) document.

In one aspect, modifying the edge margins in Step 508 includes modifying the footers and headers of the Composer file pages. Modifying the edge margins in Step 508 includes alternate substeps. Step 508a creates a page overlay. Step 508b resizes a page.

Creating a page overlay in Step 508a includes additional substeps. Step 508a1 selects edge margin areas. Step 508a2 covers the selected areas with a white opaque ribbon image. Typically, Step 508a2 creates graphical device interface (GDI) calls at the logical end of pages in the Composer file. In some aspects, following the covering of the selected areas with the white opaque ribbon image, Step 508a3 generates contents to fill the selected areas. The generated contents may include the page number, Composer file name, date, revision number, source file of the original page, line numbers, and/or a proprietary information banner, to name a few examples.

Resizing a page in Step 508b includes additional substeps. Step 508b1 selects edge margin areas. Step 508b2 creates a white opaque ribbon to cover the selected areas. Step 508b3 modifies the size of the image. Step 508b4 forms a modified page with the selected edge margins and resized image. For example, when Step 508b1 selects footer and header areas. Step 508b3 resizes the image to fit between selected footer and header areas.

More specifically, when Step 508b1 selects horizontal edge margins, then modifying the size of the image (Step 508b3) includes compressing the image as follows:

Ir=(Lp−Lhm)/Lp;

where Ir=the compression ratio of the resized image;

where Lp=page length; and,

where Lhm=length of horizontal edge margins. The formula for operating with the vertical edges is given above in the explanation of the system of FIG. 1.

A system and method have been presented for composing documents. One invention embodiment permits the manipulation of document headers and footers. However, this is just one example of how the invention can be used to compose and rework documents. The page overlay and page resizing modes of the invention have been presented as alternatives. However, it should be understood that a Composer file may be created using aspects of both techniques. Other variations and embodiments of the invention will occur to those skilled in the art.

We claim:

1. A method for composing documents comprising:
accepting at least one electronically formatted document;
converting the documents into a metafile format description; and,
arranging the converted documents in a Composer file.

2. The method of claim 1 wherein converting the documents into a metafile format description includes converting the documents into printer commands.

3. The method of claim 2 wherein converting the documents into a metafile format description includes:
creating a call for a graphical device interface (GDI) function; and,
supplying GDI function parameters.

4. The method of claim 3 wherein arranging the converted documents in a Composer file includes arranging the GDI function calls and parameters in a Windows enhanced metafile (EMF) document.

5. The method of claim 2 wherein arranging the converted documents in a Composer file includes creating a Composer file with images differentiated by logical pages; and,
the method further comprising:
modifying the edge margins of the Composer file pages.

6. The method of claim 5 wherein modifying the edge margins includes modifying the footers and headers of the Composer file pages.

7. The method of claim 6 wherein modifying the edge margins includes:
creating a page overlay; and,
resizing a page.

8. The method of claim 7 wherein creating a page overlay includes:
selecting edge margin areas; and,
covering the selected areas with a white opaque ribbon image.

9. The method of claim 8 wherein creating a page overlay further includes, following the covering of the selected areas with the white opaque ribbon image, generating contents to fill the selected areas.

10. The method of claim 9 wherein generating contents to fill the selected area include generating contents selected from the group including page number, Composer file name, date, revision number, source file of the original page, line numbers, and a proprietary information banner.

11. The method of claim 9 wherein covering the selected areas with a white opaque ribbon image includes creating graphical device interface (GDI) calls at the logical end of pages in the Composer file.

12. The method of claim 7 wherein resizing a page includes:
selecting edge margin areas;
creating a white opaque ribbon to cover the selected areas;
modifying the size of the image; and,
forming a modified page with the selected edge margins and resized image.

13. The method of claim 12 wherein selecting edge margin areas includes selecting footer and header areas; and,
wherein modifying the size of the image includes resizing the image to fit between selected footer and header areas.

14. The method of claim 12 wherein selecting edge margin areas includes selecting horizontal edge margins; and,
wherein modifying the size of the image includes compressing the image as follows:
Ir=(Lp−Lvm)/Lp;
where Ir=the compression ratio of the resized image;
where Lp=page length; and,
where Lvm=length of horizontal edge margins.

15. The method of claim 1 further comprising:
storing the Composer file.

16. A system for composing documents comprising:
a memory having an interface to accept and supply electronically formatted documents;
an operating system including a Composer printer processor having an interface to accept the documents from memory, convert the documents into a metafile format description, and supply the convert documents at an interface;
a Composer application having an interface to accept the converted documents and an interface to accept user commands, the Composer application arranging the converted documents in response to user interface commands, and supplying the composed documents at an interface; and,
a Composer file including composed documents supplied from the Composer application.

17. The system of claim 16 wherein the Composer printer processor converts the documents into printer commands.

18. The system of claim 17 wherein the Composer printer processor converts the documents into a metafile format description by creating a call for graphical device interface (GDI) functions and supplying GDI function parameters.

19. The system of claim 18 wherein the Composer file is a Windows enhanced metafile (EMF) file including the GDI function calls and parameters.

20. The system of claim 17 wherein the Composer application arranges the converted documents in a Composer file by creating a Composer file with images differentiated by logical pages, and modifies edge margins of the composer file pages in response to user interface commands.

21. The system of claim 20 wherein the Composer application modifies the footers and headers of the pages in the Composer file.

22. The system of claim 21 wherein the Composer application modifies the edge margins by:
creating a page overlay in the Composer file; and,
resizing pages in the Composer file.

23. The system of claim 22 wherein the Composer application creates a page overlay by accepting user interface commands that select the edge margin areas, and covering the selected areas with a white opaque ribbon image.

24. The system of claim 23 wherein the Composer application user interface accepts content fill instructions, and following the covering of the selected areas with the white opaque ribbon image, fills the selected areas with the accepted contents.

25. The system of claim 24 wherein the Composer application accepts user interface content fill instructions selected from the group including page number, Composer file name, date, revision number, source file for the original page, line numbers, and proprietary information banner.

26. The system of claim 24 wherein the Composer application covers the selected areas with a white opaque ribbon image by creating graphical device interface (GDI) calls at the logical end of pages in the Composer file.

27. The system of claim 22 wherein the Composer application resizes a page by accepting user interface commands that select edge margin areas and create a white opaque ribbon to cover the selected areas, the Composer application modifying the size of the image and supplying a modified page to the Composer file with the selected edge margins and resized image.

28. The system of claim 27 wherein the Composer application accepts user interface commands that select footer and header areas and resizes the image to fit between selected footer and header areas.

29. The system of claim 27 wherein the Composer application accepts user interface commands that select horizontal edge margins and compresses the image as follows:
Ir=(Lp−Lhm)/Lp;
where Ir=the compression ratio of the resized image;
where Lp=page length; and,
where Lhm=length of horizontal edge margins.

30. A method for composing documents comprising:
accepting at least one electronically formatted document;
converting the documents into a metafile format description;
arranging the converted documents in a Composer file with images differentiated by logical pages; and,
modifying the edge margins of the Composer file pages.
